(19) United States
(12) Patent Application Publication
(10) Pub. No.: US 2021/0105448 A1
(43) Pub. Date: Apr. 8, 2021

(54) MULTIPLE FRAME AUTO WHITE BALANCE

(71) Applicant: QUALCOMM Incorporated, San Diego, CA (US)

(72) Inventors: Soman Ganesh Nikhara, Hyderabad (IN); Ho Sang Lee, San Diego, CA (US); Pradeep Veeramalla, Hyderabad (IN); Anshul Maheshwari, Hyderabad (IN); Shivakumar Manda, Hyderabad (IN)

(21) Appl. No.: 16/592,648

(22) Filed: Oct. 3, 2019

(51) Int. Cl. H04N 9/73; H04N 5/232; G06T 5/50

(52) U.S. Cl. CPC H04N 9/73; H04N 5/23229; G06T 2207/10024; G06T 2207/20221; G06T 5/50

(57) ABSTRACT

Methods, systems, and devices for image processing at a device are described. The present disclosure may relate to capturing a first frame of image samples and a second frame of image samples of an image sensor after capturing the first frame of image samples, determining that a white balance confidence level of the second frame does not satisfy a confidence threshold, retrieving the first frame of image samples based on determining that the white balance confidence level of the second frame does not satisfy the confidence threshold, combining at least a portion of the image samples of the first frame with the image samples of the second frame, and determining a white balance setting for the second frame based on combining at least the portion of the image samples of the first frame with the image samples of the second frame.

### BACKGROUND

The following relates generally to image processing at a device, and more specifically to multiple frame auto white balance.

Color balance may refer to a field of image processing for the global adjustment of the intensities of colors detected by image sensors (e.g., red, green, and blue image sensors). Color balance includes adjustments made by image processors to render specific colors, particularly neutral colors, correctly. Color balance may be referred to as gray balance, neutral balance, or white balance. Color balance changes the overall mixture of colors in an image and is used for color correction.

Image data acquired by image sensors may be adjusted from acquired values to new values that are appropriate for color reproduction or display. Aspects of the acquisition and display process in color correction help match what acquisition sensors sense to what the human eye sees. But certain conditions (e.g., properties of the display medium, ambient viewing conditions compared to display viewing conditions) may cause inconsistencies in color correction processes, which may result in inconsistencies with image output generated by the image capturing device.

### SUMMARY

The described techniques relate to improved methods, systems, devices, and apparatuses that support multiple frame auto white balance. Generally, the described techniques provide for improved techniques for correcting colors (e.g., auto white balance) in images by increasing the effective field of view of a frame of image samples. Increasing the field of view of a frame of image samples may, among other benefits, increase the probability of more distinct samples, which may in turn improve the accuracy of color correction in complex scenes.

A method of image processing at a device is described. The method may include capturing a first frame of image samples and a second frame of image samples of an image sensor after capturing the first frame of image samples, determining that a white balance confidence level of the second frame does not satisfy a confidence threshold, retrieving the first frame of image samples based on determining that the white balance confidence level of the second frame does not satisfy the confidence threshold, combining at least a portion of the image samples of the first frame with the image samples of the second frame, and determining a white balance setting for the second frame based on combining at least the portion of the image samples of the first frame with the image samples of the second frame.

An apparatus for image processing at a device is described. The apparatus may include a processor, memory coupled with the processor, and instructions stored in the memory. The instructions may be executable by the processor to cause the apparatus to capture a first frame of image samples and a second frame of image samples of an image sensor after capturing the first frame of image samples, determine that a white balance confidence level of the second frame does not satisfy a confidence threshold, retrieve the first frame of image samples based on determining that the white balance confidence level of the second frame does not satisfy the confidence threshold, combine at least a portion of the image samples of the first frame with the image samples of the second frame, and determine a white balance setting for the second frame based on combining at least the portion of the image samples of the first frame with the image samples of the second frame.

Another apparatus for image processing at a device is described. The apparatus may include means for capturing a first frame of image samples and a second frame of image samples of an image sensor after capturing the first frame of image samples, determining that a white balance confidence level of the second frame does not satisfy a confidence threshold, retrieving the first frame of image samples based on determining that the white balance confidence level of the second frame does not satisfy the confidence threshold, combining at least a portion of the image samples of the first frame with the image samples of the second frame, and determining a white balance setting for the second frame based on combining at least the portion of the image samples of the first frame with the image samples of the second frame.

A non-transitory computer-readable medium storing code for image processing at a device is described. The code may include instructions executable by a processor to capture a first frame of image samples and a second frame of image samples of an image sensor after capturing the first frame of image samples, determine that a white balance confidence level of the second frame does not satisfy a confidence threshold, retrieve the first frame of image samples based on determining that the white balance confidence level of the second frame does not satisfy the confidence threshold, combine at least a portion of the image samples of the first frame with the image samples of the second frame, and determine a white balance setting for the second frame based on combining at least the portion of the image samples of the first frame with the image samples of the second frame.

Some examples of the method, apparatuses, and non-transitory computer-readable medium described herein may further include operations, features, means, or instructions for determining that a white balance confidence level of the first frame satisfies the confidence threshold, and storing the first frame in a frame buffer based on the white balance confidence level of the first frame satisfying the confidence threshold, where retrieving the first frame of image samples includes retrieving the first frame of image samples from the frame buffer.

Some examples of the method, apparatuses, and non-transitory computer-readable medium described herein may further include operations, features, means, or instructions for querying the frame buffer based on determining that the white balance confidence level of the second frame does not satisfy the confidence threshold, and determining that the first frame may be adjacent to the second frame based on the query.

Some examples of the method, apparatuses, and non-transitory computer-readable medium described herein may further include operations, features, means, or instructions for determining that at least the portion of the first frame may be adjacent to the second frame based on information associated with the first frame and a current position of the device when the second frame may be captured.

Some examples of the method, apparatuses, and non-transitory computer-readable medium described herein may further include operations, features, means, or instructions for storing metadata associated with the first frame in the frame buffer based on the first frame satisfying the confidence threshold, where the metadata includes gyro information, or depth information, or sample validity information, or distance information, or weight information, or an associated white balance confidence level, or any combination thereof.

In some examples of the method, apparatuses, and non-transitory computer-readable medium described herein, the depth information includes information obtained from an auto focus process associated with the device or a depth sensor associated with the device.

Some examples of the method, apparatuses, and non-transitory computer-readable medium described herein may further include operations, features, means, or instructions for determining a white balance setting for the first frame based on the white balance confidence level of the first frame satisfying the confidence threshold, and storing the determined white balance setting for the first frame in the frame buffer.

Some examples of the method, apparatuses, and non-transitory computer-readable medium described herein may further include operations, features, means, or instructions for determining the white balance setting for the second frame based on the determined white balance setting for the first frame.

Some examples of the method, apparatuses, and non-transitory computer-readable medium described herein may further include operations, features, means, or instructions for determining a detected change in location of the device satisfies a location change threshold, and flushing at least the first frame from the frame buffer based on the change in location of the device satisfying the location threshold.

Some examples of the method, apparatuses, and non-transitory computer-readable medium described herein may further include operations, features, means, or instructions for capturing a third frame of image samples, determining that a difference between the second frame of image samples and the third frame of image samples satisfies a difference threshold, and storing the third frame of image samples in the frame buffer based on the difference between the second frame of image samples and the third frame of image samples satisfying the difference threshold.

Some examples of the method, apparatuses, and non-transitory computer-readable medium described herein may further include operations, features, means, or instructions for determining that a difference between a field of view of the second frame and a field of view of the third frame satisfies a field of view threshold, and storing the third frame of image samples in the frame buffer based on the difference between the field of view of the second frame and the field of view of the third frame satisfying the field of view threshold.

### BRIEF DESCRIPTION OF THE DRAWINGS

FIG. 1 illustrates an example of a system for image processing at a device that supports multiple frame auto white balance in accordance with aspects of the present disclosure.

FIG. 2 illustrates an example of a system that supports multiple frame auto white balance in accordance with aspects of the present disclosure.

FIGS. 3 and 4 show block diagrams of devices that support multiple frame auto white balance in accordance with aspects of the present disclosure.

FIG. 5 shows a block diagram of an image processing manager that supports multiple frame auto white balance in accordance with aspects of the present disclosure.

FIG. 6 shows a diagram of a system including a device that supports multiple frame auto white balance in accordance with aspects of the present disclosure.

FIGS. 7 and 8 show flowcharts illustrating methods that support multiple frame auto white balance in accordance with aspects of the present disclosure.

### DETAILED DESCRIPTION

When a device with a camera is panned between a first scene (e.g., with relatively high white balance confidence) to a second scene (e.g., with relatively low white balance confidence), the white balance analysis of the scenes may change from the first scene to the second scene. These changes in white balance analysis may cause inconsistency in the white balance settings, which may result in inconsistency with the image output. In some examples, a scene may be a complex scene with relatively few decision making samples (e.g., a picture of a monotone wall), which may also increase the likelihood of inconsistency in the white balance settings.

The present techniques relate to storing calibrated frames in a buffer and using the stored calibrated frames of varying field of view (FOV) to compute a white balance decision in some scenes (e.g., complex scenes) or for panning. In some cases, the present techniques relate to using the stored calibrated frames of varying FOV to compute a white balance decision in some scenes (e.g., regular scenes) to improve white balance accuracy. In some examples, information associated with the calibrated frames (e.g., gyro information, depth information, etc.) may be used to compute the white balance decision.

In some examples, the present techniques may relate to tagging a frame with associated information (e.g., gyro information, depth information, etc.). In some examples, the tagged frame may be used to construct a frame with a larger field of view (e.g., when a frame captures a complex scene). In some examples, the larger the field of view and the more distinct the samples in a frame, the better the accuracy of the white balance output. In some examples, increasing the field of view increases, among other benefits, the probability of more distinct samples, which improves the accuracy in complex scenes.

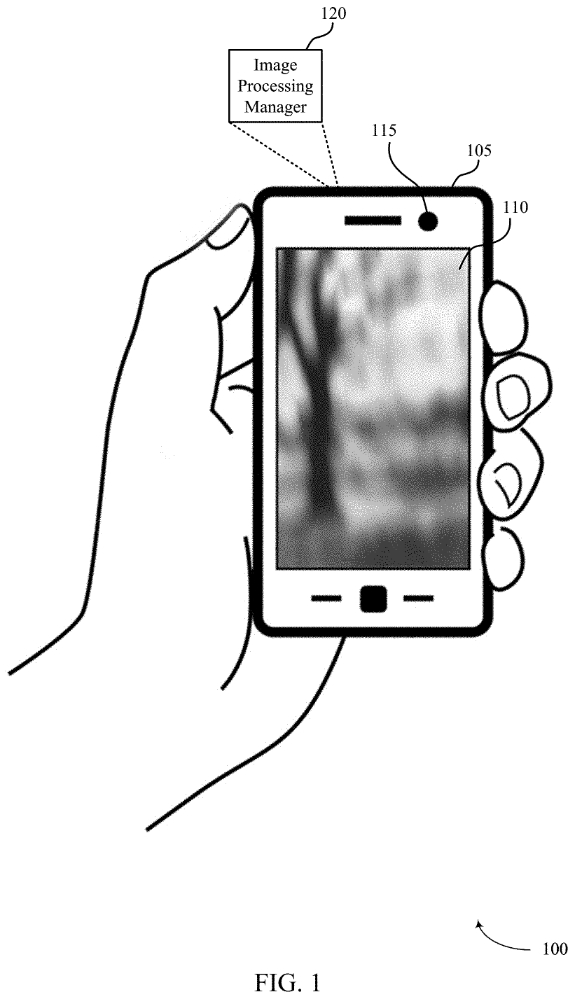

FIG. 1 illustrates an example of a system 100 that supports multiple frame auto white balance in accordance with aspects of the present disclosure. As shown, system 100 may include device 105. In the illustrated example, device 105 may include a display 110. In some examples, device 105 may include a camera 115 for capturing still images and/or video images. In some examples, camera 115 may include a front-facing camera as shown. In some examples, device 105 may also include a rear-facing camera. In one example, device 105 may capture images by an image sensor of camera 115 on device 105 that is interoperable with a processor of device 105 capable of implementing at least a portion of the aspects of the present disclosure in conjunction with the image sensor. In some examples, image processing manager 120 may include the image sensor or the processor of device 105, or both. As shown, display 110 may display pictures captured by camera 115 on device 105, and/or a camera wireless connected to device 105. In some examples, an image of system 100 may be obtained by camera 115 or by a remote device (e.g., a wireless device) and sent to device 105 via a transmission received from the remote device (e.g., over a wireless link, a wired link, a portable memory, etc.).

In some examples, camera 115 may include or operate in conjunction with one or more sensors. In some examples, camera 115 may include or operate in conjunction with one or more adjustable image sensors. In some examples, image processing manager 120 may use at least one data signal generated from the one or more sensors to process an image captured by camera 115 or captured by a remote device. Additionally or alternatively, camera 115 may include a servo motor to adjust at least one adjustable image sensor. In some examples, camera 115 may include or operate in conjunction with one or more gyro sensors. Gyro sensors, also known as angular rate sensors or angular velocity sensors, may include sensors that sense an angular velocity of device 105. In some examples, camera 115 may include or operate in conjunction with one or more depth sensors. Depth sensors may include sensors that sense a depth of objects in a field of view of camera 115 (e.g., sonar depth sensor, laser depth sensor, etc.). Depth sensors may use stereo triangulation, or sheet of light triangulation, or structured light, or time-of-flight, or interferometry, or coded aperture, or any combination thereof, to determine a distance to points in an image captured by camera 115 or captured by a remote device.

As shown, device 105 may include an image processing manager 120. Aspects of the present disclosure relate to the image processing manager 120 enabling improved techniques for automatic white balance when camera 115 is used in complex scenes (e.g., capturing an image in relatively low light conditions, capturing an image when multiple light sources illuminate the scene, capturing an image of a monotone or uniformly-colored subject, capturing an image with a relatively small field of view, capturing an image with a relatively shallow depth of field) and with non-complex scenes (e.g., capturing an image in a relatively high level of light, capturing an image when a single light source illuminates the scene capturing an image of multiple colors or a non-uniformly colored subject, capturing an image with relatively high contrasts between pixels, points, or subjects in the captured image, capturing an image with a relatively large field of view, capturing an image with a relatively deep depth of field).

In some examples, image processing manager 120, in conjunction with camera 115, may capture one or more images. In some examples, image processing manager 120, in conjunction with camera 115, may capture one or more frames of image samples. In some examples, an image sample may correspond to an output of a pixel of an image sensor. For example, a frame of image samples may include the output of one or more pixels of an image sensor (e.g., the outputs of at least a portion of pixels of an image sensor). In some examples, a frame of image samples may include the output of each pixel of the image sensor. In some examples, image processing manager 120 may perform white balance analysis on the one or more captured frames of image samples.

In some examples, image processing manager 120 may determine a validity of a frame of image samples. In some examples, the validity of a frame of image samples may be based on a number of gray or near-gray samples included in a frame of image samples. In some examples, validity of a frame may be based on how many gray or near gray image samples are included in the frame of image samples. For example, when the number of gray or near gray image samples in the frame of image samples satisfy a validity threshold (e.g., a number of valid samples meets or exceeds a validity threshold), the frame may be considered valid. In some examples, the validity of a frame of image samples may be based on a number of errors associated with capturing the frame of image samples. For example, image processing manager 120 may determine a frame of image samples is valid when a number of errors associated with capturing the frame of image samples does not satisfy an error threshold.

In one example, a first frame of image samples may be associated with a sufficient number of valid samples and/or a relatively high white balance confidence, and a second frame of image samples may be associated with an insufficient number of valid samples and/or a relatively low white balance confidence. In this example, a sufficient number of valid samples (e.g., gray or near gray samples) of the first frame of image samples may satisfy a confidence threshold. In some examples, when the number of valid samples of the first frame of image samples captured by image processing manager 120 satisfies a confidence threshold, image processing manager 120 may generate a white balance output with a certain degree of confidence in the white balance accuracy (e.g., greater than 50% chance white balance is accurate, greater than 60% chance white balance is accurate, etc.). In some examples, when the number of valid samples of the second frame of image samples captured by image processing manager 120 fails to satisfy the confidence threshold, image processing manager 120 may generate a dynamic white balance output based on performing white balance analysis on the second frame of image samples combined with at least a portion of one or more previously captured frames of image samples.

In some examples, image processing manager 120 may determine distance information associated with a frame of image samples. In some examples, the distance information may be associated with a distance between a first frame of image samples and a second frame of image samples. In some examples, the distance between a first frame of image samples and a second frame of image samples may be based on a degree of difference in a first scene captured in first frame of image samples and a second scene captured in second frame of image samples.

In some examples, image processing manager 120 may determine weight information associated with a frame of image samples. In some examples, a first frame of image samples may be assigned a greater weight than a second frame of image samples. In some examples, a frame of image samples may be assigned a weight based on a number of valid samples included in the frame of image samples, based on light conditions associated the frame of image samples (e.g., low weight for low light conditions, higher weight for sufficient light conditions, etc.), based on a uniqueness of a scene captured in the frame of image samples (e.g., a frame buffer does not include the scene captured in the frame of image samples or is different from a scene already stored in the frame buffer, etc.), or other factors, or any combination thereof.

In some examples, image processing manager 120, in conjunction with camera 115, may capture a first frame of image samples of an image sensor. In some examples, image processing manager 120 may perform white balance analysis on at least some the first frame of image samples and determine a confidence level of the first frame of image samples. In some examples, image processing manager 120 may determine that the white balance confidence level of the first frame of image samples satisfies (e.g., exceeds) a confidence threshold. In some examples, image processing manager 120 may store the first frame in a frame buffer based at least in part on the white balance confidence level of the first frame satisfying the confidence threshold.

In some examples, image processing manager 120 may store information (e.g., metadata) associated with the first frame in the frame buffer based at least in part on the first frame satisfying the confidence threshold. In some examples, the metadata may include gyro information from a gyro sensor of device 105, or depth information from a depth sensor of device 105, or image sample validity information, or distance information, or weight information, or an associated white balance confidence level, or other information, or any combination thereof. In some examples, the depth information may include information image processing manager 120 obtains by performing an auto focus process of device 105.

In some examples, image processing manager 120 may determine a white balance setting for the first frame based at least in part on the white balance confidence level of the first frame satisfying the confidence threshold. In some examples, image processing manager 120 may store the determined white balance setting for the first frame in the frame buffer.

In some examples, image processing manager 120 may capture a second frame of image samples of the image sensor after capturing the first frame of image samples. In some examples, image processing manager 120 may determine the white balance setting for the second frame. In some examples, image processing manager 120 may determine the white balance setting for the second frame based at least in part on the determined white balance setting for the first frame. In some examples, image processing manager 120 may determine that a white balance confidence level of the second frame does not satisfy a confidence threshold. In some examples, image processing manager 120 may retrieve the first frame of image samples based at least in part on determining that the white balance confidence level of the second frame does not satisfy the confidence threshold. In some examples, the image processing manager 120 may retrieve the first frame of image samples from the frame buffer.

In some examples, image processing manager 120 may combine at least a portion of the image samples of the first frame with at least a portion of the image samples of the second frame. In some examples, image processing manager 120 may determine a white balance setting for the second frame based at least in part on combining at least the portion of the image samples of the first frame with at least the portion of the image samples of the second frame. For example, image processing manager 120 may determine a white balance setting for the combination of at least the portion of the image samples of the first frame with the image samples of the second frame.

In some examples, image processing manager 120 may query the frame buffer based at least in part on determining that the white balance confidence level of the second frame does not satisfy the confidence threshold. In some examples, image processing manager 120 may determine that the second frame is adjacent to (e.g., the second frame is directly adjacent to the first frame, a portion of the second frame overlaps a portion of the first frame, the second frame is captured within a certain number of degrees (e.g., within 45 degrees in a given direction, or within 90 degrees in a given direction, etc.) of the first frame, second frame is associated with a same scene as the first frame) the first frame based at least in part on the query. In some examples, image processing manager 120 may combine the at least a portion of the image samples of the first frame with the image samples of the second frame based at least in part on determining that the first frame is adjacent to the second frame. In some examples, image processing manager 120 may determine that at least the portion of the first frame is adjacent to the second frame based at least in part on information associated with the first frame and a current position of device 105 when device 105 captures the second frame.

The present techniques improve white balance processes (e.g., auto white balance) performed by image capturing devices, such as device 105. For example, the present techniques make auto white balance more robust in panning scenarios such as when device 105 pans a scene. Also, the present techniques improve the accuracy of the auto white balance processes in complex scenes. In some examples, the present techniques may transform an aspect of a frame of image samples captured in a complex scene to be similar to an aspect of a frame of image samples captured in a non-complex scene. For example, the present techniques may add at least a portion of a first frame of image samples to a second frame of image samples to increase a field of view associated with the second frame of image samples, or to increase a depth of field associated with the second frame of image samples, or to increase color variation associated with the second frame of image samples, or to minimize a low light condition associated with the second frame of image samples, or other benefits, or any combination thereof.

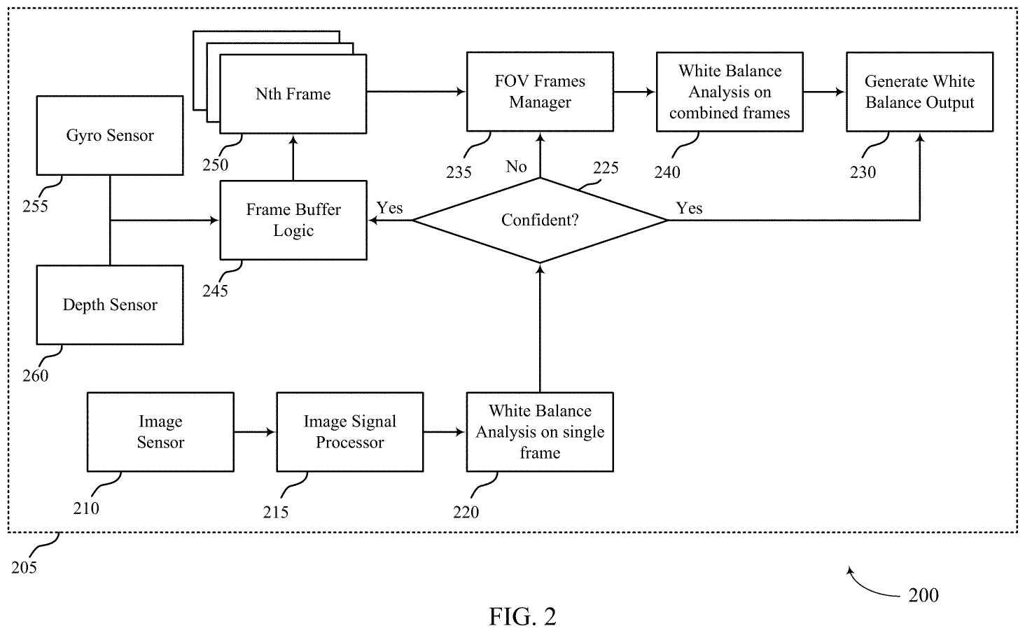

FIG. 2 illustrates an example of a system 200 that supports multiple frame auto white balance in accordance with aspects of the present disclosure. In some examples, system 200 may implement aspects of system 100.

System 200 may include device 205. In some examples, device 205 may be an example of device 105, or camera 115, or image processing manager 120, or any combination thereof. As shown, device 205 may include image sensor 210, image signal processor 215, field of view (FOV) frames manager 235, frame buffer logic 245, frame buffer 250, gyro sensor 255, and depth sensor 260.

In some examples, image sensor 210 may capture one or more frames of image samples. For example, image sensor 210 may include a group or matrix of pixels and at least a portion of those pixels may capture image samples of a scene or field of view. In one example, each pixel in the at least portion of pixels captures an image sample. In some examples, an image sample includes light information, or a light level, or color information, or a color level, or any combination thereof. In some examples, the light information may include an electrical signal that corresponds to a number of photons that are detected by a pixel of the image sensor.

In some examples, image signal processor 215 may process one or more frames of image samples captured by image sensor 210. In some examples, image signal processor 215 may analyze electrical signals (e.g., generated from photons detected by pixels) of image sensor 210 and generate the one or more frames of image samples based on the analysis.

At 220, image signal processor 215 may perform white balance analysis on a frame of image samples captured by image sensor 210. In some examples, the white balance analysis may include determining the color of one or more pixels, points, or subjects in the frame of image samples. In some examples, the white balance analysis may include a color correction process to correct the color of one or more pixels, points, or subjects in the frame of image samples. In some examples, the white balance analysis may include determining a confidence level associated with a result of determining the color or performing the color correction process on the one or more pixels, points, or subjects in the frame of image samples.

In some examples, image signal processor 215 performing white balance analysis at 220 may include image signal processor 215 determining which image samples in a frame of image samples are gray or near gray. For example, image signal processor 215 may filter the incident light using a color filter array (e.g., Bayer filter array) that converts incident photons into red information, green information, or blue information at each pixel of image sensor 210 (e.g., a green filtered pixel detects green information, but not red information or blue information). Image signal processor 215 may perform a demosaicing algorithm to generate a red information image, a blue information image, and a green information image. In some cases, image signal processor 215 may analyze the separate images to compute or interpolate a color value at a given pixel or sample. Accordingly, image signal processor 215 may determine whether a sample or pixel includes a gray or near-gray value.

In some examples, a confidence level of a frame may be based on how many gray or near gray image samples are included in the frame of image samples. For example, when the number of gray or near gray image samples in the frame of image samples satisfies a validity threshold, image signal processor 215 may determine that the frame is valid.

In some examples, image signal processor 215 may then determine whether a variety among the gray or near-gray samples enable image signal processor 215 to accurately determine color values for pixels, points, or subjects captured in the frame of image samples. In some examples, when the number of valid samples of a frame of image samples captured by image sensor 210 satisfies the confidence threshold, image signal processor 215 may generate a white balance output at 230 with a certain degree of confidence in the white balance accuracy (e.g., greater than 50% chance white balance is accurate, greater than 60% chance white balance is accurate, etc.).

At 225, image signal processor 215 may compare the determined confidence level to a confidence threshold to determine whether the confidence level of the frame of image samples satisfies (e.g., exceeds) the confidence threshold. In some examples, image signal processor 215 may determine that color values associated with at least a portion of the image samples from the frame of image samples more than likely (e.g., with relatively high confidence) accurately depict the actual colors of the scene captured by image sensor 210 when by image sensor 210 captured the frame of image samples.

At 230, image signal processor 215 may generate a white balance output for a frame of image samples captured by image sensor 210. For example, when the confidence level of the frame of image samples satisfies the confidence threshold, image signal processor 215 may output a white balance output that indicates color information for at least a portion of the image samples from the frame of image samples. In some examples, at 230 image signal processor 215 may modify a value associated with a least one image sample from the frame of image samples based on the white balance analysis at 220.

In some examples, in an 8-bit 0 to 255 color scale, a pixel of image sensor 210 may detect a red color value of 203, which corresponds to a color value for one image sample from a frame of image samples. In some examples, image sensor 210 may determine a red value, or a green value, or a blue value, or any combination thereof. In some examples, a pixel of image sensor 210 may detect a first color value (e.g., green color value) and estimate a second color value (e.g., red color value) and a third color value (e.g., blue color value) based on a level of the detected first color value.

After the pixel of image sensor 210 detect a red color value of 203, image signal processor 215 may adjust the red color value based on the white balance analysis at 220. For example, based on the white balance analysis at 220, image signal processor 215 may increase the red color value (e.g., adjust to 218, etc.) or decrease the red color value (e.g., adjust to 187, etc.). Accordingly, at 230, image signal processor 215 may output a white balance output based on original color values detected by the pixels of image sensor 210 and associated with the image samples of a frame of image samples. Additionally or alternatively, image signal processor 215 may output a white balance output based on modifying one or more color values (e.g., color correction) associated with image samples from the frame of image samples.

In some examples, when the confidence level of a frame of image samples satisfies the confidence threshold at 225 the frame of image samples may be referred to as a confident frame of image samples. As shown, in addition to using the white balance values of a confident frame of image samples to generate a white balance output at 230 for the confident frame of image samples, image signal processor 215 may send the confident frame of image samples to frame buffer logic 245. In some examples, frame buffer logic 245 may store a confident frame of image samples in frame buffer 250. As shown, frame buffer 250 may include one or more different confident frames of image samples (e.g., N different confident frames of image samples). In some examples, frame buffer logic 245 may be part of or operate in conjunction with image signal processor 215.

In some examples, frame buffer logic 245 may determine whether to store a confident frame of image samples in the frame buffer 250 based on whether the confident frame of image samples is similar to one or more confident frames of image samples already stored in the frame buffer 250. In one example, frame buffer logic 245 may prohibit a confident frame of image samples from being stored in the frame buffer 250 when an aspect of the confident frame of image samples is too similar to an aspect of one or more confident frames of image samples already stored in the frame buffer 250. For example, frame buffer logic 245 may determine that a scene captured by a second confident frame of image samples largely overlaps with a scene captured by a first confident frame of image samples already stored in the frame buffer 250, and as a result, frame buffer logic 245 may block the second confident frame of image samples from being stored in the frame buffer 250.

In some examples, frame buffer logic 245 may associate metadata with a frame of image samples stored at frame buffer 250. Examples of metadata frame buffer logic 245 may associate and store with a frame of image samples stored at frame buffer 250 includes gyro information, or depth information, or sample validity information, or distance information, or weight information, or an associated white balance confidence level, or any combination thereof. For example, frame buffer logic 245 may associate gyro information from gyro sensor 255 with a frame of image samples stored at frame buffer 250 and may store in the frame buffer 250 the associated gyro information with the frame of image samples.

Additionally or alternatively, frame buffer logic 245 may associate depth information from depth sensor 260 with a frame of image samples stored at frame buffer 250 and may store in the frame buffer 250 the associated depth information with the frame of image samples. In some examples, the metadata may be data captured or sensed at the same time or relatively at the same time a frame of image samples is captured by image sensor 210. For example, gyro sensor 255 may sense gyro information (e.g., movement associated with device 205) at the time a frame of image samples are captured, and frame buffer logic may store at least a portion of this gyro information with the corresponding frame of image samples in frame buffer 250.

In some examples, frame buffer logic 245 may track a location of device 205. In some examples, frame buffer logic 245 may allow one or more frames to continue to be stored in the frame buffer 250 after determining the location of the device 205 has remained relatively unchanged. For example, frame buffer logic 245 may allow one or more frames to continue to be stored in the frame buffer 250 after determining the device 205 has not moved more than 10 feet from an initial location.

In some examples, frame buffer logic 245 may allow one or more frames to continue to be stored in the frame buffer 250 after determining the location of the device 205 has remained relatively unchanged for a given time period (e.g., 1 second, 5 seconds 10 seconds, etc.). In some examples, frame buffer logic 245 may flush one or more frames stored in frame buffer 250 when frame buffer logic determines that a location of device 205 has changed.

For example, frame buffer logic 245 may store one or more frames captured at a first location in frame buffer 250 and may maintain the one or more captured frames in frame buffer 250 as long as device 205 remains at the first location. When frame buffer logic 245 determines that device 205 has moved or is moving to a second location (e.g., a location change of device 205 satisfies a range threshold), frame buffer logic 245 may flush from the frame buffer 250 at least one of the frames captured at the first location.

At 225, image signal processor 215 may compare the determined confidence level of a current frame of image samples to a confidence threshold and determine that the confidence level fails to satisfy (e.g., fails to satisfy) the confidence threshold. When image signal processor 215 determines that the confidence level of the current frame of image samples fails to satisfy the confidence threshold, image signal processor 215 may send a query to FOV frames manager 235.

In some examples, the query may include a request for FOV frames manager 235 to determine whether frame buffer 250 includes one or more confident frames of image samples that are adjacent to the current frame of image samples. In some examples, FOV frames manager 235 may use metadata associated with the current frame of image samples or metadata associated with the one or more confident frames of image samples stored in frame buffer 250, or metadata from both, to determine whether the one or more confident frames of image samples in frame buffer 250 are adjacent to the current frame of image samples. For example, gyro information associated with the current frame of image samples and/or gyro information associated with a first confident frame of image samples stored in the frame buffer 250 may indicate that a scene captured by the current frame of image samples is adjacent to or at least partially overlaps with a scene captured by the first confident frame of image samples.

At 240, after determining the first confident frame of image samples is adjacent to the current frame of image samples, image signal processor 215 may perform white balance analysis on the current frame of image samples and at least a portion of the first confident frame of image samples.

In some examples, image signal processor 215 may fuse the current frame of image samples with at least a portion of the first confident frame of image samples after determining the first confident frame of image samples is adjacent to the current frame of image samples. In some examples, FOV frames manager 235 may fuse the current frame of image samples with two or more confident frames of image samples.

For example, FOV frames manager 235 may fuse the current frame of image samples with at least a portion of the first confident frame of image samples and at least a portion of a second confident frame of image samples after determining that at least the first confident frame of image samples and the second confident frame of image samples are adjacent to the current frame of image samples. Accordingly, at 240 image signal processor 215 may perform white balance analysis on the current frame of image samples fused with at least a portion of the first confident frame of image samples and at least a portion of the second confident frame of image samples.

In one example, the current frame of image samples may include 3,000 samples. In some examples, the first confident frame of image samples and the second confident frame of image samples may each include 3,000 samples. Accordingly, fusing the first confident frame of image samples and the second confident frame of image samples with the current frame of image samples results in a combined frame of 9,000 image samples.

Accordingly, at 240 image signal processor 215 may perform white balance analysis on the combined frame of 9,000 image samples when the current frame of image samples fails to satisfy the confidence threshold. It is noted that in some examples, the first confident frame of image samples or the second confident frame of image samples may include more or less samples than the current frame of image samples.

In some examples, FOV frames manager 235 may determine whether there is a sufficient difference in image samples between the first confident frame of image samples and the current frame of image samples. When FOV frames manager 235 determines a sufficient difference in image samples exists between the image samples of the first confident frame and the current frame of image sample, FOV frames manager 235 may allow the at least portion of image samples of the first confident frame to be fused with the image samples of the current frame.

In some examples, FOV frames manager 235 may determine whether the image samples of the first confident frame overlap with the image samples of the current frame. When FOV frames manager 235 determines that the image samples of the first confident frame do not overlap with the image samples of the current frame, FOV frames manager 235 may allow the at least portion of image samples of the first confident frame to be fused with the image samples of the current frame. However, when FOV frames manager 235 determines that the image samples of the first confident frame overlap with at least a portion of the image samples of the current frame, FOV frames manager 235 may prohibit any portion of image samples of the first confident frame to be fused with the image samples of the current frame.

Accordingly, device 205 improves white balance processes (e.g., auto white balance) performed. For example, the described operations of device 205 make auto white balance more robust in panning scenarios such as when device 205 pans a scene. Also, device 205 improves the accuracy of the white balance processes in complex scenes by increasing a field of view associated with a frame of image samples, or increasing a depth of field associated with a frame of image samples, or increasing color variation associated with a frame of image samples, or minimizing low light conditions associated with a frame of image samples, or any combination thereof.

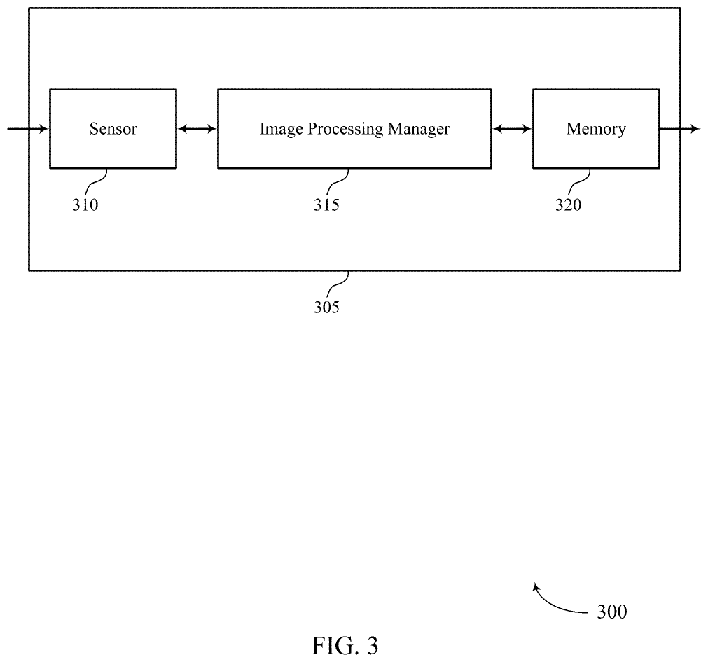

FIG. 3 shows a block diagram 300 of a device 305 that supports multiple frame auto white balance in accordance with aspects of the present disclosure. The device 305 may be an example of aspects of a device as described herein. The device 305 may include a sensor 310, an image processing manager 315, and a memory 320. The device 305 may also include a processor. Each of these components may be in communication with one another (e.g., via one or more buses).

Sensor 310 may include or be an example of a digital imaging sensor for taking photos and video. In some examples, sensor 310 may receive information such as packets, user data, or control information associated with various information channels (e.g., from a transceiver 1220 described with reference to FIG. 12). Information may be passed on to other components of the device. Additionally or alternatively, components of device 1005 used to communicate data over a wireless (e.g., or wired) link may be in communication with image processing block 1015 (e.g., via one or more buses) without passing information through sensor 310. The sensor 310 may be an example of aspects of the camera 115 described with reference to FIG. 1. The sensor 310 may be an example of aspects of the image sensor 210, or gyro sensor 255, or depth sensor 260, or any combination thereof described with reference to FIG. 2. The sensor 310 may be an example of sensor 410 with reference to FIG. 3.

The image processing manager 315 may capture a first frame of image samples and a second frame of image samples of an image sensor after capturing the first frame of image samples, retrieve the first frame of image samples based on determining that the white balance confidence level of the second frame does not satisfy the confidence threshold, determine that a white balance confidence level of the second frame does not satisfy a confidence threshold, determine a white balance setting for the second frame based on combining at least the portion of the image samples of the first frame with the image samples of the second frame, and combine at least a portion of the image samples of the first frame with the image samples of the second frame. The image processing manager 315 may be an example of aspects of the image processing manager 610 described herein.

The image processing manager 315, or its sub-components, may be implemented in hardware, code (e.g., software or firmware) executed by a processor, or any combination thereof. If implemented in code executed by a processor, the functions of the image processing manager 315, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The image processing manager 315, or its sub-components, may be physically located at various positions, including being distributed such that portions of functions are implemented at different physical locations by one or more physical components. In some examples, the image processing manager 315, or its sub-components, may be a separate and distinct component in accordance with various aspects of the present disclosure. In some examples, the image processing manager 315, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

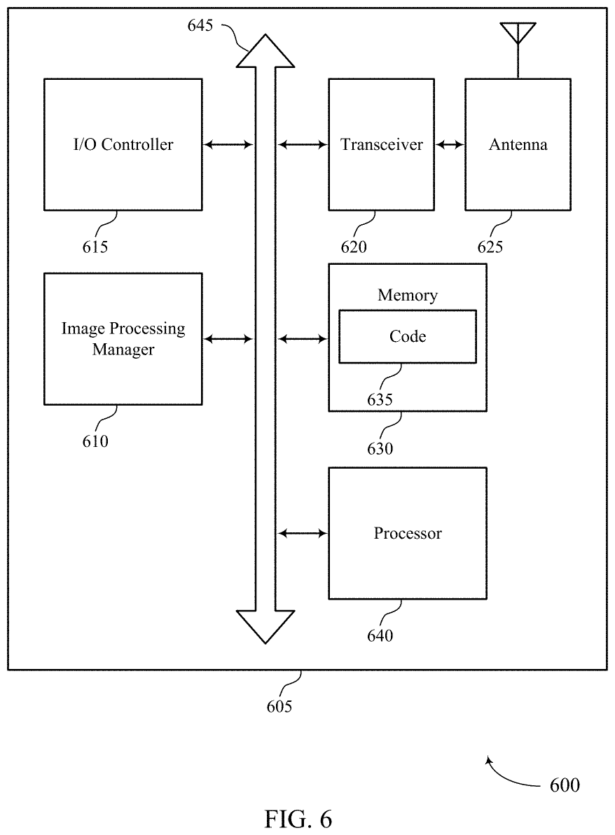

Memory 320 may store information (e.g., facial feature information) generated by other components of the device such as image processing manager 315. For example, memory 320 may store one or more frames of images samples with which to compare an output of image processing block 1015. In some examples, the memory 320 may be collocated with a sensor 310 in an imaging device. For example, the memory 320 may be an example of aspects of the memory 630 described with reference to FIG. 6. Memory 320 may comprise one or more computer-readable storage media. Examples of memory 320 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., image processing manager 315).

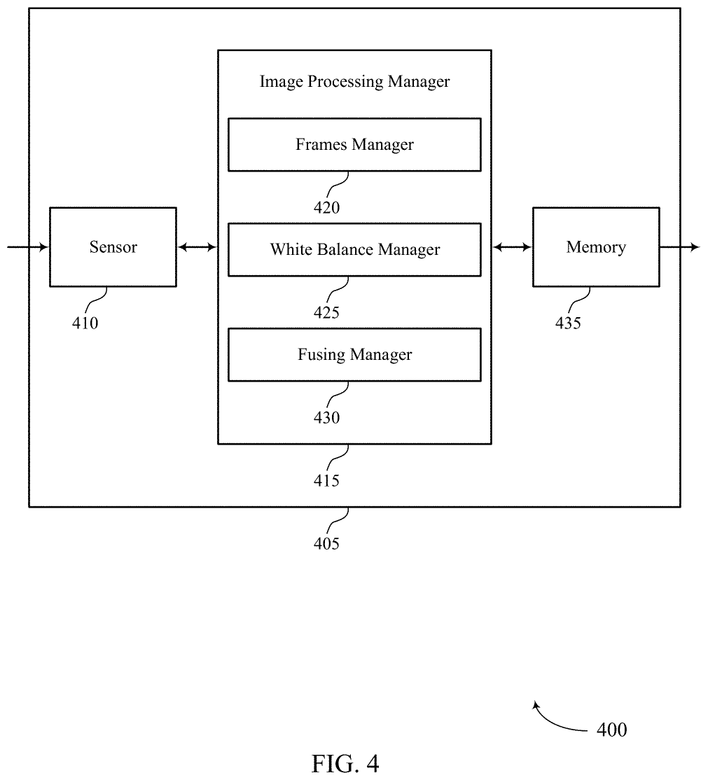

FIG. 4 shows a block diagram 400 of a device 405 that supports multiple frame auto white balance in accordance with aspects of the present disclosure. The device 405 may be an example of aspects of a device 305, or a device 205, or a device 105 as described herein. The device 405 may include a sensor 410, an image processing manager 415, and a memory 435. The device 405 may also include a processor. Each of these components may be in communication with one another (e.g., via one or more buses).

The sensor 410 may sense conditions associated with device 405 capturing one or more frames of image samples. Sensor data may be passed on to other components of the device 405. The sensor 410 may be an example of aspects of the camera 115 described with reference to FIG. 1. The sensor 410 may be an example of aspects of the image sensor 210, or gyro sensor 255, or depth sensor 260, or any combination thereof described with reference to FIG. 2. The sensor 410 may be an example of sensor 310 with reference to FIG. 3.

The image processing manager 415 may be an example of aspects of the image processing manager 315 as described herein. The image processing manager 415 may include a frames manager 420, a white balance manager 425, and a fusing manager 430. The image processing manager 415 may be an example of aspects of the image processing manager 610 described herein.

The frames manager 420 may capture a first frame of image samples and a second frame of image samples of an image sensor after capturing the first frame of image samples and retrieve the first frame of image samples based on determining that the white balance confidence level of the second frame does not satisfy the confidence threshold.

The white balance manager 425 may determine that a white balance confidence level of the second frame does not satisfy a confidence threshold and determine a white balance setting for the second frame based on combining at least the portion of the image samples of the first frame with the image samples of the second frame.

The fusing manager 430 may combine at least a portion of the image samples of the first frame with the image samples of the second frame.

The memory 435 may receive, transmit, or store information, data, or signals generated by other components of the device 405. In some examples, the memory 435 may be collocated with a sensor 410 in an imaging device. For example, the memory 435 may be an example of aspects of memory 630 described with reference to FIG. 6.

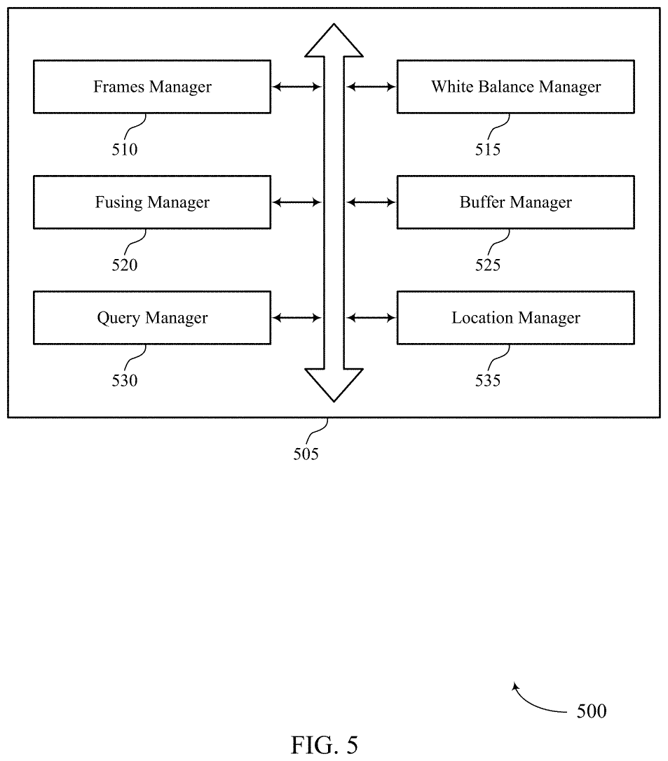

FIG. 5 shows a block diagram 500 of an image processing manager 505 that supports multiple frame auto white balance in accordance with aspects of the present disclosure. The image processing manager 505 may be an example of aspects of an image processing manager 315, an image processing manager 415, or an image processing manager 610 described herein. The image processing manager 505 may include a frames manager 510, a white balance manager 515, a fusing manager 520, a buffer manager 525, a query manager 530, and a location manager 535. Each of these modules may communicate, directly or indirectly, with one another (e.g., via one or more buses).

The frames manager 510 may capture a first frame of image samples and a second frame of image samples of an image sensor after capturing the first frame of image samples. In some examples, the white balance manager 515 may determine that a white balance confidence level of the first frame satisfies a confidence threshold. In some examples, the white balance manager 515 may determine a white balance setting for the first frame based on the white balance confidence level of the first frame satisfying the confidence threshold.

The buffer manager 525 may store the first frame in a frame buffer based on the white balance confidence level of the first frame satisfying the confidence threshold, where retrieving the first frame of image samples includes retrieving the first frame of image samples from the frame buffer.

In some examples, storing metadata associated with the first frame in the frame buffer based on the first frame satisfying the confidence threshold, where the metadata includes gyro information, or depth information, or sample validity information, or distance information, or weight information, or an associated white balance confidence level, or any combination thereof. In some examples, the buffer manager 525 may store the determined white balance setting for the first frame in the frame buffer. In some examples, the depth information includes information obtained from an auto focus process associated with the device or a depth sensor associated with the device.

In some examples, the white balance manager 515 may determine that a white balance confidence level of the second frame does not satisfy a confidence threshold. The query manager 530 may query the frame buffer based on determining that the white balance confidence level of the second frame does not satisfy the confidence threshold.

In some examples, the frames manager 510 may retrieve the first frame of image samples based on determining that the white balance confidence level of the second frame does not satisfy the confidence threshold.

In some examples, the frames manager 510 may determine that the first frame is adjacent to the second frame based on the query. In some examples, the frames manager 510 may determine that at least the portion of the first frame is adjacent to the second frame based on information associated with the first frame and a current position of the device when the second frame is captured. In some examples, the frames manager 510 may retrieve the first frame of image samples based on determining that the first frame is adjacent to the second frame.

In some examples, the white balance manager 515 may determine the white balance setting for the second frame based on the determined white balance setting for the first frame. In some examples, the white balance manager 515 may determine a white balance setting for the second frame based on combining at least the portion of the image samples of the first frame with the image samples of the second frame. For example, the fusing manager 520 may combine, fuse, or stitch together at least a portion of the image samples of the first frame with the image samples of the second frame, and the white balance manager 515 may determine a white balance setting for the second frame based on the white balance setting of the combination of the image samples of the second frame combined with the at least portion of the image samples of the first frame.

In some examples, the frames manager 510 may capture a third frame of image samples. In some examples, the buffer manager 525 may determine that a difference between the second frame of image samples and the third frame of image samples satisfies a difference threshold. In some examples, the buffer manager 525 may store the third frame of image samples (e.g., that satisfies the confidence threshold) in the frame buffer based on the difference between the second frame of image samples and the third frame of image samples satisfying the difference threshold.

For example, buffer manager 525 may determine that a scene captured by the second frame does not overlap a scene captured by the third frame. Accordingly, buffer manager 525 may allow the third frame to be stored in the frame buffer. In some examples, buffer manager 525 may determine whether a scene captured by the second frame is sufficiently different from a scene captured by the third frame to allow the third frame to be stored in the frame buffer. For example, buffer manager 525 may determine that a scene captured by the second frame does overlap a scene captured by the third frame, but that the overlap does not satisfy an overlap threshold or a certain percentage. For example, buffer manager 525 may determine that the scene captured by the second frame overlaps 10% or less of the scene captured by the third frame. Thus, in some examples buffer manager 525 may allow the third frame to be stored in the frame buffer as long as the overlap does not satisfy the overlap threshold.

In some examples, the buffer manager 525 may determine that a difference between a field of view of the second frame and a field of view of the third frame satisfies a field of view threshold. In some examples, the buffer manager 525 may store the third frame of image samples in the frame buffer based on the difference between the field of view of the second frame and the field of view of the third frame satisfying the field of view threshold.

The location manager 535 may determine a detected change in location of the device satisfies a location change threshold. In some examples, the buffer manager 525 may flush at least one frame (e.g., the first frame) from the frame buffer based on the change in location of the device satisfying the location threshold. In some examples, location manager 535 may detect the change in location based at least in part on a global positioning system or local positioning system determining the location of the device.

FIG. 6 shows a diagram of a system 600 including a device 605 that supports multiple frame auto white balance in accordance with aspects of the present disclosure. The device 605 may be an example of or include the components of device 305, device 405, or a device as described herein. The device 605 may include components for bi-directional voice and data communications including components for transmitting and receiving communications, including an image processing manager 610, an I/O controller 615, a transceiver 620, an antenna 625, memory 630, and a processor 640. These components may be in electronic communication via one or more buses (e.g., bus 645).

The image processing manager 610 may capture a first frame of image samples and a second frame of image samples of an image sensor after capturing the first frame of image samples, retrieve the first frame of image samples based on determining that the white balance confidence level of the second frame does not satisfy the confidence threshold, determine that a white balance confidence level of the second frame does not satisfy a confidence threshold, determine a white balance setting for the second frame based on combining at least the portion of the image samples of the first frame with the image samples of the second frame, and combine at least a portion of the image samples of the first frame with the image samples of the second frame.

The I/O controller 615 may manage input and output signals for the device 605. The I/O controller 615 may also manage peripherals not integrated into the device 605. In some examples, the I/O controller 615 may represent a physical connection or port to an external peripheral. In some examples, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some examples, the I/O controller 615 may be implemented as part of a processor. In some examples, a user may interact with the device 605 via the I/O controller 615 or via hardware components controlled by the I/O controller 615.

The transceiver 620 may communicate bi-directionally, via one or more antennas, wired, or wireless links as described above. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas.

In some examples, the wireless device may include a single antenna 625. However, in some examples the device may have more than one antenna 625, which may be capable of concurrently transmitting or receiving multiple wireless transmissions.

The memory 630 may include RAM and ROM. The memory 630 may store computer-readable, computer-executable code 635 including instructions that, when executed, cause the processor to perform various functions described herein. In some examples, the memory 630 may contain, among other things, a BIOS which may control basic hardware or software operation such as the interaction with peripheral components or devices.

The processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some examples, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks supporting multiple frame auto white balance). In some cases, image processing manager 315 may include or operate in conjunction with one or more processors (e.g., processor 640). In some cases, at least one component or sub-manager of image processing manager 315 may include or operate in conjunction with one or more processors (e.g., processor 640).

The code 635 may include instructions to implement aspects of the present disclosure, including instructions to support image processing at a device. The code 635 may be stored in a non-transitory computer-readable medium such as system memory or other type of memory. In some examples, the code 635 may not be directly executable by the processor 640 but may cause a computer (e.g., when compiled and executed) to perform functions described herein.

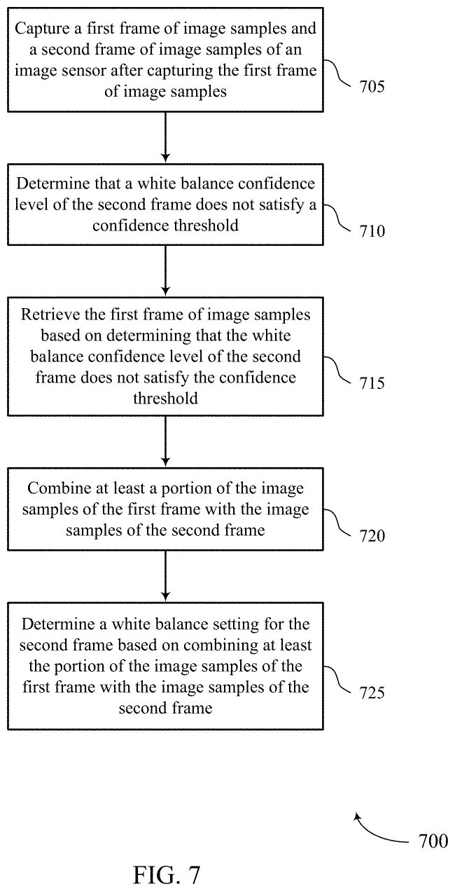

FIG. 7 shows a flowchart illustrating a method 700 that supports multiple frame auto white balance in accordance with aspects of the present disclosure. The operations of method 700 may be implemented by a device or its components as described herein. For example, the operations of method 700 may be performed by an image processing manager as described with reference to FIGS. 3 through 6. In some examples, a device may execute a set of instructions to control the functional elements of the device to perform the functions described below. Additionally or alternatively, a device may perform aspects of the functions described below using special-purpose hardware.

At 705, the device may capture a first frame of image samples and a second frame of image samples of an image sensor after capturing the first frame of image samples. The operations of 705 may be performed according to the methods described herein. In some examples, aspects of the operations of 705 may be performed by a frames manager as described with reference to FIGS. 3 through 6.

At 710, the device may determine that a white balance confidence level of the second frame does not satisfy a confidence threshold. The operations of 710 may be performed according to the methods described herein. In some examples, aspects of the operations of 710 may be performed by a white balance manager as described with reference to FIGS. 3 through 6.

At 715, the device may retrieve the first frame of image samples based on determining that the white balance confidence level of the second frame does not satisfy the confidence threshold. The operations of 715 may be performed according to the methods described herein. In some examples, aspects of the operations of 715 may be performed by a frames manager as described with reference to FIGS. 3 through 6.

At 720, the device may combine at least a portion of the image samples of the first frame with the image samples of the second frame. The operations of 720 may be performed according to the methods described herein. In some examples, aspects of the operations of 720 may be performed by a fusing manager as described with reference to FIGS. 3 through 6.

At 725, the device may determine a white balance setting for the second frame based on combining at least the portion of the image samples of the first frame with the image samples of the second frame. The operations of 725 may be performed according to the methods described herein. In some examples, aspects of the operations of 725 may be performed by a white balance manager as described with reference to FIGS. 3 through 6.

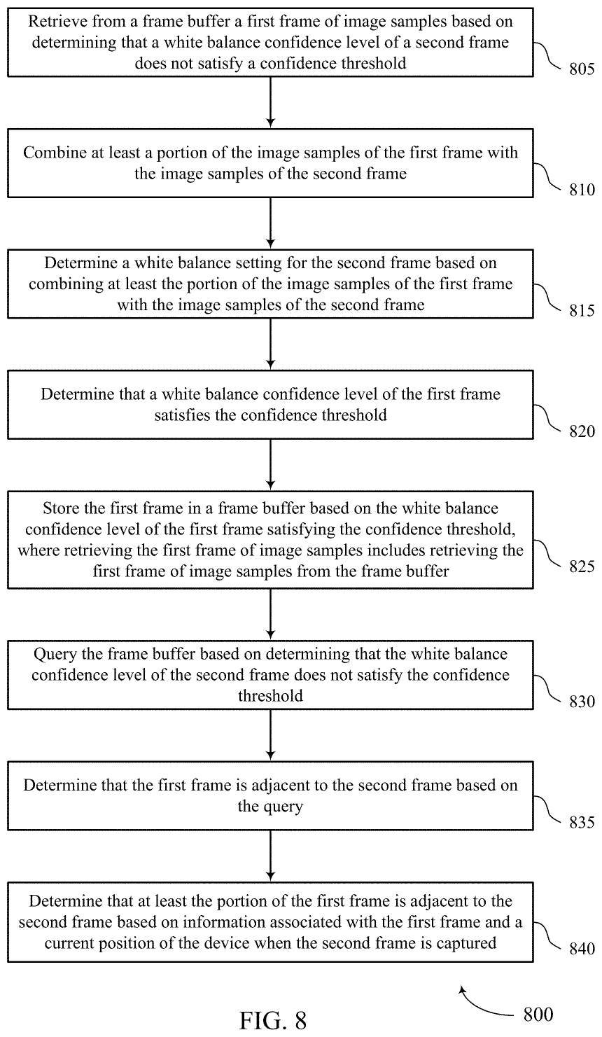

FIG. 8 shows a flowchart illustrating a method 800 that supports multiple frame auto white balance in accordance with aspects of the present disclosure. The operations of method 800 may be implemented by a device or its components as described herein. For example, the operations of method 800 may be performed by an image processing manager as described with reference to FIGS. 3 through 6. In some examples, a device may execute a set of instructions to control the functional elements of the device to perform the functions described below. Additionally or alternatively, a device may perform aspects of the functions described below using special-purpose hardware.

At 805, the device may retrieve a first frame of image samples from a frame buffer based on determining that a white balance confidence level of a second frame does not satisfy a confidence threshold. The operations of 805 may be performed according to the methods described herein. In some examples, aspects of the operations of 805 may be performed by a frames manager as described with reference to FIGS. 3 through 6.

At 810, the device may combine at least a portion of the image samples of the first frame with the image samples of the second frame. The operations of 810 may be performed according to the methods described herein. In some examples, aspects of the operations of 810 may be performed by a fusing manager as described with reference to FIGS. 3 through 6.

At 815, the device may determine a white balance setting for the second frame based on combining at least the portion of the image samples of the first frame with the image samples of the second frame. The operations of 815 may be performed according to the methods described herein. In some examples, aspects of the operations of 815 may be performed by a white balance manager as described with reference to FIGS. 3 through 6.

At 820, the device may determine that a white balance confidence level of the first frame satisfies the confidence threshold. The operations of 820 may be performed according to the methods described herein. In some examples, aspects of the operations of 820 may be performed by a white balance manager as described with reference to FIGS. 3 through 6.

At 825, the device may store the first frame in a frame buffer based on the white balance confidence level of the first frame satisfying the confidence threshold, where retrieving the first frame of image samples includes retrieving the first frame of image samples from the frame buffer. The operations of 825 may be performed according to the methods described herein. In some examples, aspects of the operations of 825 may be performed by a buffer manager as described with reference to FIGS. 3 through 6.

At 830, the device may query the frame buffer based on determining that the white balance confidence level of the second frame does not satisfy the confidence threshold. The operations of 830 may be performed according to the methods described herein. In some examples, aspects of the operations of 830 may be performed by a query manager as described with reference to FIGS. 3 through 6.

At 835, the device may determine that the first frame is adjacent to the second frame based on the query. The operations of 835 may be performed according to the methods described herein. In some examples, aspects of the operations of 835 may be performed by a frames manager as described with reference to FIGS. 3 through 6.

At 840, the device may determine that at least the portion of the first frame is adjacent to the second frame based on information associated with the first frame and a current position of the device when the second frame is captured. The operations of 840 may be performed according to the methods described herein. In some examples, aspects of the operations of 840 may be performed by a frames manager as described with reference to FIGS. 3 through 6.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
capturing a first frame of image samples and a second frame of image samples of an image sensor after capturing the first frame of image samples;
determining that a white balance confidence level of the second frame does not satisfy a confidence threshold;
retrieving the first frame of image samples based at least in part on determining that the white balance confidence level of the second frame does not satisfy the confidence threshold;
combining at least a portion of the image samples of the first frame with the image samples of the second frame; and
determining a white balance setting for the second frame based at least in part on combining at least the portion of the image samples of the first frame with the image samples of the second frame.

2. The method of claim 1, further comprising:
determining that a white balance confidence level of the first frame satisfies the confidence threshold; and
storing the first frame in a frame buffer based at least in part on the white balance confidence level of the first frame satisfying the confidence threshold, wherein retrieving the first frame of image samples comprises retrieving the first frame of image samples from the frame buffer.

3. The method of claim 2, further comprising:
querying the frame buffer based at least in part on determining that the white balance confidence level of the second frame does not satisfy the confidence threshold; and
determining that the first frame is adjacent to the second frame based at least in part on the query.

4. The method of claim 3, further comprising:
determining that at least the portion of the first frame is adjacent to the second frame based at least in part on information associated with the first frame and a current position of the device when the second frame is captured.

5. The method of claim 2, further comprising:
storing metadata associated with the first frame in the frame buffer based at least in part on the first frame satisfying the confidence threshold, wherein the metadata comprises gyro information, or depth information, or sample validity information, or distance information, or weight information, or an associated white balance confidence level, or any combination thereof.

6. The method of claim 5, wherein the depth information comprises information obtained from an auto focus process associated with the device or a depth sensor associated with the device.

7. The method of claim 2, further comprising:
determining a white balance setting for the first frame based at least in part on the white balance confidence level of the first frame satisfying the confidence threshold; and
storing the determined white balance setting for the first frame in the frame buffer.

8. The method of claim 7, further comprising:
determining the white balance setting for the second frame based at least in part on the determined white balance setting for the first frame.

9. The method of claim 2, further comprising:
determining a detected change in location of the device satisfies a location change threshold; and
flushing at least the first frame from the frame buffer based at least in part on the change in location of the device satisfying the location threshold.

10. The method of claim 1, further comprising:
capturing a third frame of image samples;
determining that a difference between the second frame of image samples and the third frame of image samples satisfies a difference threshold; and
storing the third frame of image samples in the frame buffer based at least in part on the difference between the second frame of image samples and the third frame of image samples satisfying the difference threshold.

11. The method of claim 10, further comprising:
determining that a difference between a field of view of the second frame and a field of view of the third frame satisfies a field of view threshold; and
storing the third frame of image samples in the frame buffer based at least in part on the difference between the field of view of the second frame and the field of view of the third frame satisfying the field of view threshold.

12. An apparatus for image processing, comprising:
a processor,
memory coupled with the processor; and
instructions stored in the memory and executable by the processor to cause the apparatus to:
capture a first frame of image samples and a second frame of image samples of an image sensor after capturing the first frame of image samples;
determine that a white balance confidence level of the second frame does not satisfy a confidence threshold;
retrieve the first frame of image samples based at least in part on determining that the white balance confidence level of the second frame does not satisfy the confidence threshold;
combine at least a portion of the image samples of the first frame with the image samples of the second frame; and
determine a white balance setting for the second frame based at least in part on combining at least the portion of the image samples of the first frame with the image samples of the second frame.

13. The apparatus of claim 12, wherein the instructions are further executable by the processor to cause the apparatus to:
determine that a white balance confidence level of the first frame satisfies the confidence threshold; and
the instructions to store the first frame in a frame buffer based at least in part on the white balance confidence level of the first frame satisfying the confidence threshold, wherein retrieving the first frame of image samples are executable by the processor to cause the apparatus to retrieve the first frame of image samples from the frame buffer.

14. The apparatus of claim 13, wherein the instructions are further executable by the processor to cause the apparatus to:
query the frame buffer based at least in part on determining that the white balance confidence level of the second frame does not satisfy the confidence threshold; and
determine that the first frame is adjacent to the second frame based at least in part on the query.

15. The apparatus of claim 14, wherein the instructions are further executable by the processor to cause the apparatus to:
determine that at least the portion of the first frame is adjacent to the second frame based at least in part on information associated with the first frame and a current position of the apparatus when the second frame is captured.

16. The apparatus of claim 13, wherein the instructions are further executable by the processor to cause the apparatus to:
store metadata associated with the first frame in the frame buffer based at least in part on the first frame satisfying the confidence threshold, wherein the metadata comprises gyro information, or depth information, or sample validity information, or distance information, or weight information, or an associated white balance confidence level, or any combination thereof.

17. The apparatus of claim 16, wherein the depth information comprises information obtained from an auto focus process of the apparatus or a depth sensor associated with the apparatus.

18. The apparatus of claim 13, wherein the instructions are further executable by the processor to cause the apparatus to:
determine a white balance setting for the first frame based at least in part on the white balance confidence level of the first frame satisfying the confidence threshold; and
store the determined white balance setting for the first frame in the frame buffer.

19. A non-transitory computer-readable medium storing code for image processing at a device, the code comprising instructions executable by a processor to:
capture a first frame of image samples and a second frame of image samples of an image sensor after capturing the first frame of image samples;
determine that a white balance confidence level of the second frame does not satisfy a confidence threshold;
retrieve the first frame of image samples based at least in part on determining that the white balance confidence level of the second frame does not satisfy the confidence threshold;
combine at least a portion of the image samples of the first frame with the image samples of the second frame; and
determine a white balance setting for the second frame based at least in part on combining at least the portion of the image samples of the first frame with the image samples of the second frame.

20. The non-transitory computer-readable medium of claim 19, wherein the instructions are further executable to:
determine that a white balance confidence level of the first frame satisfies the confidence threshold; and
the instructions to store the first frame in a frame buffer based at least in part on the white balance confidence level of the first frame satisfying the confidence threshold, wherein retrieving the first frame of image samples are executable by the processor to cause the apparatus to retrieve the first frame of image samples from the frame buffer.
